(19) United States
(12) Patent Application Publication
(10) Pub. No.: US 2022/0206103 A1
(43) Pub. Date: Jun. 30, 2022

(54) LOCATION ESTIMATION SYSTEM, LOCATION ESTIMATION METHOD, PROGRAM, AND RECORDING MEDIUM

(71) Applicant: NEC Corporation, Minato-ku, Tokyo (JP)

(72) Inventor: Toshiki TAKEUCHI, Tokyo (JP)

(73) Assignee: NEC Corporation, Minato-ku, Tokyo (JP)

(21) Appl. No.: 17/606,500

(22) PCT Filed: Apr. 30, 2020
(86) PCT No.: PCT/JP2020/018248

§ 371 Date: Oct. 26, 2021

(30) Foreign Application Priority Data
May 13, 2019 (JP) 2019-090646

(51) Int. Cl. G01S 5/02

(52) U.S. Cl. CPC G01S 5/0264; G01S 5/0244; G01S 5/0278

(57) ABSTRACT

A location estimation system includes: a first location estimating unit configured to estimate first location information related to a target object; a second location estimating unit configured to estimate second location information related to a target object; an association determining unit configured to determine association between the target object whose location is estimated from the first location information and the target object whose location is estimated from the second location information, based on the first location information and the second location information; a weight calculating unit configured to calculate correct location information of the target object and weighting information of the correct location information, based on accuracy information of the second location information and determination results of the association; and a parameter updating unit configured to update a parameter for estimating the first location information, based on the correct location information and the weighting information.

### BACKGROUND

### Technical Field

The present invention relates to a location estimation system, a location estimation method, a program, and a recording medium that perform integration (sensor fusion) of a plurality of pieces of location information by collaborating the pieces of location information and the like estimated using a plurality of sensors such as a camera and a radio wave sensor, for example, to achieve high accuracy.

### Background Art

A system as follows has hitherto been proposed: In the system, a target object (also including a person) and a radio terminal are detected and identified by using various sensors such as a camera, a radar, a radio wave sensor, and an acoustic sensor, and the location of the object and the terminal is estimated and tracked.

Further, in recent years, an integrated collaboration system (sensor fusion) among a plurality of sensors as follows has also been proposed: In the integrated collaboration system, location information, identification information, and the like acquired with various sensors are integrated to complement pros and cons of the individual sensors, so as to enable tracking of the target object including a blind area of a part of the sensors as well.

In order to achieve high accuracy through integration of the location information and the identification information of the target object detected with various sensors, determining which target object and which target object are identical among the target objects detected with each of the sensors and association (correspondence, linkage, collation, identification, matching) between the target objects have importance. When the association is performed correctly, pieces of information among a plurality of sensors related to the target object can be integrated to enable achievement of high accuracy. In contrast, when the association is performed incorrectly, different target objects may be judged as one target object, which may be a cause of wrong detection and reduction in accuracy. Thus, association processing among the target objects detected among a plurality of sensors is important processing in the integrated collaboration system (sensor fusion) among the plurality of sensors.

Further, as a method for enhancing location estimation accuracy of the target object using any sensor (for example, a radio wave sensor) by itself, the following method has also been proposed: In the method, with the use of location estimation results or the like of the target object by another sensor (for example, a camera), parameters used in a case of location estimation processing by the sensor (radio wave sensor) are learned and updated, so as to enhance location estimation accuracy of the sensor.

For example, NPL 1 describes a method in which a target is identified with a camera, and location estimation parameters of a radio base are learned based on location estimation results thereof. This is for improving an issue that location estimation accuracy of radio is lower than that of an image, with a focus being placed on the relationship that a blind area of a camera can be complemented with location estimation of the radio base.

Further, PTL 1 describes an apparatus that automatically recognizes association between a person and a terminal apparatus. Specifically, in PTL 2, the location of the person detected with a camera and the location of a mobile terminal detected with a radio wave sensor are compared, and when the distance therebetween is equal to or less than a threshold, the person and the terminal apparatus are associated with each other. With this configuration, even when there are a plurality of targets in the angle of view of the camera, the terminal apparatus and a person who carries the terminal apparatus can be associated with each other.

Further, PTL 2 describes that, when a detected object and its object ID are associated with each other with an association means (109), variance of posterior distribution calculated from an observed value and predicted distribution is used as a weighting value.

In addition, PTL 3 describes that correction parameters are learned based on information of a camera.

### CITATION LIST

### Patent Literature

[PTL 1] JP 2009-284442 A
[PTL 2] WO 2010/095437 A1
[PTL 3] JP 2018-515825 A

### Non Patent Literature

[NPL 1] Kentaro Taniguchi and two others, “A Study on Indoor Localization Using Radio and Camera Cooperation”, IEICE Technical Report, CQ2018-28, June 2018

### SUMMARY

### Technical Problem

However, in the technique described in NPL 1, when the location information of the target object seen with the camera is used directly as a correct value, location estimation accuracy may be deteriorated on the contrary, which presents an issue. As the reason of the deterioration of the location estimation accuracy, for example, two factors can be considered. The first factor is that, when there are a plurality of targets in the angle of view of the camera, wrong locations of the targets may be returned as the correct value. The second factor is that a location estimation error of the camera may be larger depending on a place or the like, such as an area distant from the camera.

Further, in the technique described in PTL 1, when general Euclidean distance is used for distance calculation and a fixed value is set as a threshold for comparison, wrong association may occur or association may not be able to be performed depending on location estimation accuracy of both the sensors, which presents an issue. Specifically, when a relatively small threshold is set, the true target is excluded from association candidates, which increases a probability of wrong association, whereas when a relatively large threshold is set, a plurality of targets are regarded as association candidates, which increases a probability that association cannot be easily performed.

Further, in the technique described in PTL 2, the variance of the posterior distribution calculated from the observed value and the predicted distribution is merely used as a weight of processing performed in the association means (109), and there is no consideration regarding the location estimation accuracy of the sensors described above.

In addition, in the technique described in PTL 3, the correction parameters are merely learned and determined based on information in the cameras or between the cameras, each of which is a single sensor, and there is no consideration regarding the location estimation accuracy of the sensors described above.

The example object of the present invention is to provide a location estimation system, a location estimation method, a program, and a recording medium that enable accurate estimation of location information.

### Solution to Problem

According to an aspect of the present invention, a location estimation system includes: a first location estimating unit configured to estimate first location information related to a target object; a second location estimating unit configured to estimate second location information related to a target object; an association determining unit configured to determine association between the target object whose location is estimated from the first location information and the target object whose location is estimated from the second location information, based on the first location information and the second location information; a weight calculating unit configured to calculate correct location information of the target object and weighting information of the correct location information, based on accuracy information of the second location information and determination results of the association; and a parameter updating unit configured to update a parameter for estimating the first location information, based on the correct location information and the weighting information.

According to an aspect of the present invention, a location estimation method includes: estimating first location information related to a target object; estimating second location information related to a target object; determining association between the target object whose location is estimated from the first location information and the target object whose location is estimated from the second location information, based on the first location information and the second location information; calculating correct location information of the target object and weighting information of the correct location information, based on accuracy information of the second location information and determination results of the association; and updating a parameter for estimating the first location information, based on the correct location information and the weighting information.

According to an aspect of the present invention, a program causes a processor to execute: estimating first location information related to a target object; estimating second location information related to a target object; determining association between the target object whose location is estimated from the first location information and the target object whose location is estimated from the second location information, based on the first location information and the second location information; calculating correct location information of the target object and weighting information of the correct location information, based on accuracy information of the second location information and determination results of the association; and updating a parameter for estimating the first location information, based on the correct location information and the weighting information.

According to an aspect of the present invention, a recording medium is a non-transitory computer readable recording medium storing a program that causes a processor to execute: estimating first location information related to a target object; estimating second location information related to a target object; determining association between the target object whose location is estimated from the first location information and the target object whose location is estimated from the second location information, based on the first location information and the second location information; calculating correct location information of the target object and weighting information of the correct location information, based on accuracy information of the second location information and determination results of the association; and updating a parameter for estimating the first location information, based on the correct location information and the weighting information.

### Advantageous Effects of Invention

According to the present invention, the location information can be accurately estimated. Note that, according to the present invention, instead of or together with the above effects, other effects may be exerted.

### BRIEF DESCRIPTION OF THE DRAWINGS

FIG. 1 is a diagram illustrating an overall configuration of a location estimation system 100 according to a first example embodiment;

FIG. 2 is a diagram illustrating an operation flow of the location estimation system 100 according to the first example embodiment;

FIGS. 3A to 3C are diagrams illustrating examples of probability distribution in location estimation processing for each of various sensors;

FIG. 4 is a diagram in which examples of accuracy information (probability distribution and magnitude of errors) in the location estimation processing for each of the various sensors illustrated in FIG. 3 are compared and organized;

FIG. 5 is a diagram illustrating an operation flow example of association determination processing;

FIGS. 6A and 6B are diagrams illustrating advantages of the association determination processing by an association determining unit 71;

FIGS. 7A and 7B are diagrams illustrating examples of weight calculation in a weight calculating unit 72;

FIGS. 8A and 8B are diagrams illustrating operation examples of learning and updating of parameters in a parameter updating unit 33;

FIG. 9 is a diagram illustrating operation of learning of location accuracy and updating of an association determination criterion in a location accuracy learning unit 73;

FIG. 10 is a diagram illustrating an overall configuration of a location estimation system 101 according to a second example embodiment of the present invention;

FIG. 11 is a diagram illustrating an example of operation of a sensor fusion unit 51 according to the second example embodiment;

FIGS. 12A and 12B are diagrams illustrating examples of operation of a location information integrating unit 81 in the sensor fusion unit 51;

FIG. 13 is a diagram illustrating an example of an operation flow of parameter updating units 33, 43, and 63 in various sensor units;

FIG. 14 is a diagram in which examples of the accuracy information (probability distribution and magnitude of errors) in the location estimation processing for each of the various sensors are compared and organized in a case of extending a method of the present example embodiment to a three-dimensional space; and

FIG. 15 is a block diagram illustrating an example of a schematic configuration of a location estimation system 102 according to a third example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of Present Invention

2. First Example Embodiment

3. Second Example Embodiment

4. Third Example Embodiment

5. Effects of Example Embodiments

6. Other Example Embodiments

### 1. Overview of Example Embodiments of Present Invention

First, an overview of example embodiments of the present invention will be described.

(1) Technical Issues

A system as follows has hitherto been proposed: In the system, a target object (also including a person) and a radio terminal are detected and identified by using various sensors such as a camera, a radar, a radio wave sensor, and an acoustic sensor, and the location of the object and the terminal is estimated and tracked.

Further, in recent years, an integrated collaboration system (sensor fusion) among a plurality of sensors as follows has also been proposed: In the integrated collaboration system, location information, identification information, and the like acquired with various sensors are integrated to complement pros and cons of the individual sensors, so as to enable tracking of the target object including a blind area of a part of the sensors as well.

In order to achieve high accuracy through integration of the location information and the identification information of the target object detected with various sensors, determining which target object and which target object are identical among the target objects detected with each of the sensors and association (correspondence, linkage, collation, identification, matching) between the target objects have importance. When the association is performed correctly, pieces of information among a plurality of sensors related to the target object can be integrated to enable achievement of high accuracy. In contrast, when the association is performed incorrectly, different target objects may be judged as one target object, which may be a cause of wrong detection and reduction in accuracy. Thus, association processing among the target objects detected among a plurality of sensors is important processing in the integrated collaboration system (sensor fusion) among the plurality of sensors.

Further, as a method for enhancing location estimation accuracy of the target object using any sensor (for example, a radio wave sensor) by itself, the following method has also been proposed: In the method, with the use of location estimation results or the like of the target object by another sensor (for example, a camera), parameters used in a case of location estimation processing by the sensor (radio wave sensor) are learned and updated, so as to enhance location estimation accuracy of the sensor.

For example, NPL 1 describes a method in which a target is identified with a camera, and location estimation parameters of a radio base are learned based on location estimation results thereof. This is for improving an issue that location estimation accuracy of radio is lower than that of an image, with a focus being placed on the relationship that a blind area of a camera can be complemented with location estimation of the radio base.

Further, PTL 2 describes an apparatus that automatically recognizes association between a person and a terminal apparatus. Specifically, in PTL 2, the location of the person detected with a camera and the location of a mobile terminal detected with a radio wave sensor are compared, and when the distance therebetween is equal to or less than a threshold, the person and the terminal apparatus are associated with each other. With this configuration, even when there are a plurality of targets in the angle of view of the camera, the terminal apparatus and a person who carries the terminal apparatus can be associated with each other.

Further, PTL 2 describes that, when a detected object and its object ID are associated with each other with an association means (109), variance of posterior distribution calculated from an observed value and predicted distribution is used as a weighting value.

In addition, PTL 3 describes that correction parameters are learned based on information of a camera.

However, in the technique described in NPL 1, when the location information of the target object seen with the camera is used directly as a correct value, location estimation accuracy may be deteriorated on the contrary, which presents a problem. As the reason of the deterioration of the location estimation accuracy, for example, two factors can be considered. The first factor is that, when there are a plurality of targets in the angle of view of the camera, wrong locations of the targets may be returned as the correct value. The second factor is that a location estimation error of the camera may be larger depending on a place or the like, such as an area distant from the camera.

Further, in the technique described in PTL 1, when general Euclidean distance is used for distance calculation and a fixed value is set as a threshold for comparison, wrong association may occur or association may not be able to be performed depending on location estimation accuracy of both the sensors, which presents a problem. Specifically, when a relatively small threshold is set, the true target is excluded from association candidates, which increases a probability of wrong association, whereas when a relatively large threshold is set, a plurality of targets are regarded as association candidates, which increases a probability that association cannot be easily performed.

Further, in the technique described in PTL 2, the variance of the posterior distribution calculated from the observed value and the predicted distribution is merely used as a weight of processing performed in the association means (109), and there is no consideration regarding the location estimation accuracy of the sensors described above.

In addition, in the technique described in PTL 3, the correction parameters are merely learned and determined based on information in the cameras or between the cameras, each of which is a single sensor, and there is no consideration regarding the location estimation accuracy of the sensors described above.

The example object of the present example embodiments is to accurately estimate location information. More specifically, the example object of the present example embodiment is, as a method for enhancing the location estimation accuracy of the target object using any sensor (for example, a radio wave sensor) by itself, to more appropriately enhance the location estimation accuracy when the parameters used in a case of the location estimation processing by the sensor (radio wave sensor) are learned and updated using location estimation results or the like of the target object by another sensor (for example, a camera).

(2) Technical Features

In the present example embodiment, for example, first location information related to a target object is estimated, second location information related to a target object is estimated, association between the target object whose location is estimated from the first location information and the target object whose location is estimated from the second location information are determined based on the first location information and the second location information, correct location information of the target object and weighting information of the correct location information are calculated based on accuracy information of the second location information and determination results of the association; and a parameter for estimating the first location information is updated based on the correct location information and the weighting information.

With this configuration, for example, the location information can be accurately estimated.

Note that the above-described technical features are concrete examples of the example embodiments of the present invention, and the example embodiments of the present invention are, of course, not limited to the above-described technical features.

The example embodiments of the present invention will be described below in detail. The first example embodiment will provide detailed description of basic configurations, features, and operations of a radio wave detecting unit, an image analyzing unit, and a sensor fusion unit for implementing a location estimation method as an example of a location estimation system.

Further, the second example embodiment will describe an example of adding a function of causing the image analyzing unit using a camera and a radar analyzing unit to learn parameters in a case where there is a location estimation error in each of various sensor analyzing units and a location obtained by integrating their location estimation results is used as a correct location.

### 2. First Example Embodiment

(1) Configuration

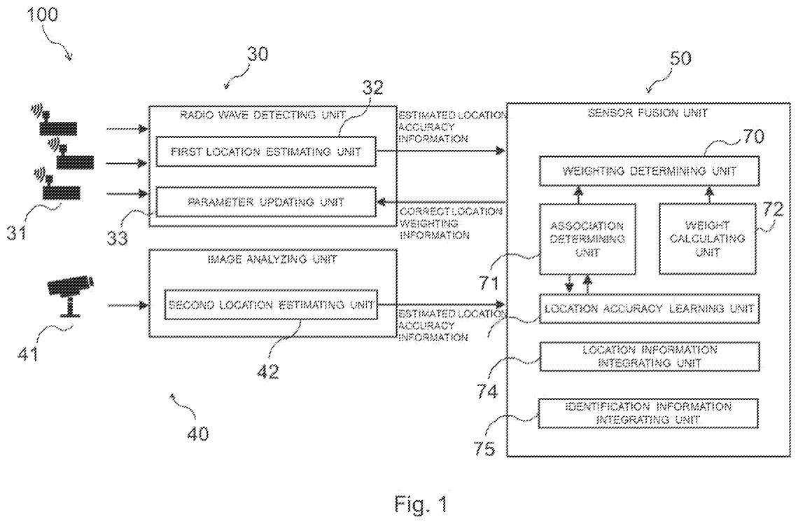

FIG. 1 is a diagram illustrating an overall configuration of a location estimation system 100 according to the first example embodiment. The location estimation system 100 is a location estimation system that includes various sensor analyzing units such as a radio wave detecting unit 30 and an image analyzing unit 40, in which association between radio wave analysis results and image analysis results is performed to be integrated with a sensor fusion unit 50, and a plurality of pieces of sensor information for achieving high accuracy of the location information and the identification information are used.

The radio wave detecting unit 30 includes one or a plurality of radio wave sensors 31, a first location estimating unit 32, and a parameter updating unit 33. For example, the radio wave detecting unit 30 performs location estimation and identification of an emission source with the first location estimating unit 32 by using strength information of radio waves received by the plurality of radio wave sensors 31, and outputs first location information (location estimation information) and identification information. In this case, the first location estimating unit 32 also calculates and outputs accuracy information (probability distribution of errors, standard deviation, or the like) in location estimation processing of the first location information. The parameter updating unit 33 performs learning processing of parameters for estimating the first location information, based on correct location information and weighting information transmitted from the sensor fusion unit 50 to be described later.

The image analyzing unit 40 includes one or a plurality of cameras 41 and a second location estimating unit 42. The image analyzing unit 40 performs image analysis processing such as face authentication, human recognition, object recognition, and moving object detection by using image information captured with the camera 41, performs location estimation processing of a recognized target with the second location estimating unit 42, and outputs second location information and identification information as image analysis results. In this case, the second location estimating unit 42 also outputs accuracy information (probability distribution of errors, standard deviation, or the like) in the location estimation processing of the second location information.

The sensor fusion unit 50 integrates the location estimation information (the first location information and the second location information), the accuracy information, the identification information, and the like from the radio wave detecting unit 30 and the image analyzing unit 40 to achieve high accuracy. Specifically, the sensor fusion unit 50 includes a weighting determining unit 70 that transmits the correct location information of the target object and its weighting information to the radio wave detecting unit 30, an association determining unit 71 that determines which target object and which target object are associated with each other among the target objects detected with each sensor, a weight calculating unit 72 that calculates a weighting value for location estimation results of the target objects detected with each sensor, and a location accuracy learning unit 73 that learns location estimation errors of the targets detected with each sensor based on the association determination results.

For example, the association determining unit 71 determines association between the target object whose location is estimated from the first location information and the target object whose location is estimated from the second location information, based on the first location information and the second location information. The weight calculating unit 72 calculates the correct location information of the target object and the weighting information of the correct location information, based on the accuracy information of the second location information and the determination results of the association. Then, the weighting determining unit 70 transmits the correct location information and the weighting information of the correct location information to the radio wave detecting unit 30 by using the association determination results by the association determining unit 71 and the weighting value by the weight calculating unit 72.

Further, in addition to the above, the sensor fusion unit 50 may include a location information integrating unit 74 that integrates the location information based on association results of the association determining unit 71, an identification information integrating unit 75 that integrates the identification information, and the like.

(2) Operation

Next, operation of the first example embodiment will be described.

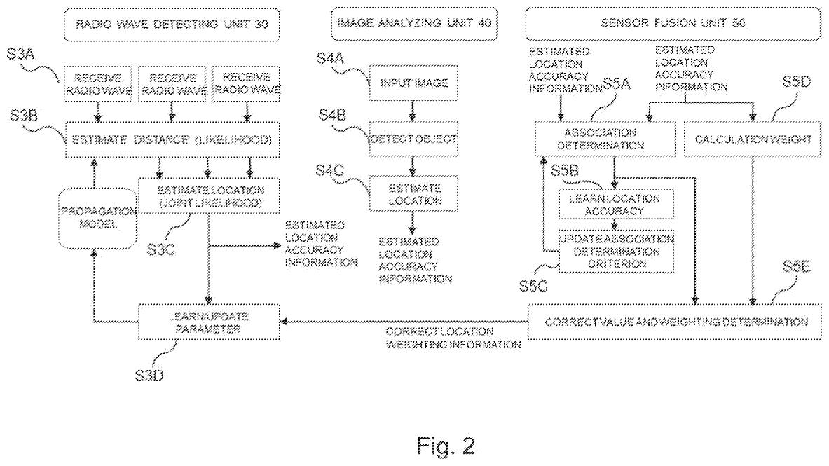

FIG. 2 is a diagram illustrating an operation flow of the location estimation system 100 according to the first example embodiment. As the operation of the first example embodiment, first, in the various sensor analyzing units being the radio wave detecting unit 30 and the image analyzing unit 40, detection and identification of target objects and location estimation processing of the target objects are performed. For example, the radio wave detecting unit 30 detects a specific emission source with radio wave information received in the plurality of radio wave sensors 31 (Step S3A). Then, the first location estimating unit 32 first estimates a distance (likelihood) from each radio wave sensor by using strength information of received radio waves and a model (propagation constant or the like) of a propagation environment (Step S3B), integrates distance (likelihood) information from each radio wave sensor, and thereby estimates the location information (the first location information) of the emission source (Step S3C). Further, the image analyzing unit 40 uses the image information captured with the camera 41 (Step S4A), performs the image analysis processing such as face authentication, human recognition, object recognition, and moving object detection (Step S4B), and estimates location coordinates (the second location information) of the recognized target with the second location estimating unit 42 (Step S4C).

Here, at the time of the location estimation processing of the target object in the various sensor analyzing units being the radio wave detecting unit 30 and the image analyzing unit 40, the accuracy information of location estimation is calculated with the first location estimating unit 32 and the second location estimating unit 42. Examples of the accuracy information include probability distribution of location estimation likelihood (two-dimensional Gaussian distribution, isotropic Gaussian distribution, normal distribution, or the like), standard deviation and variance thereof, and the like.

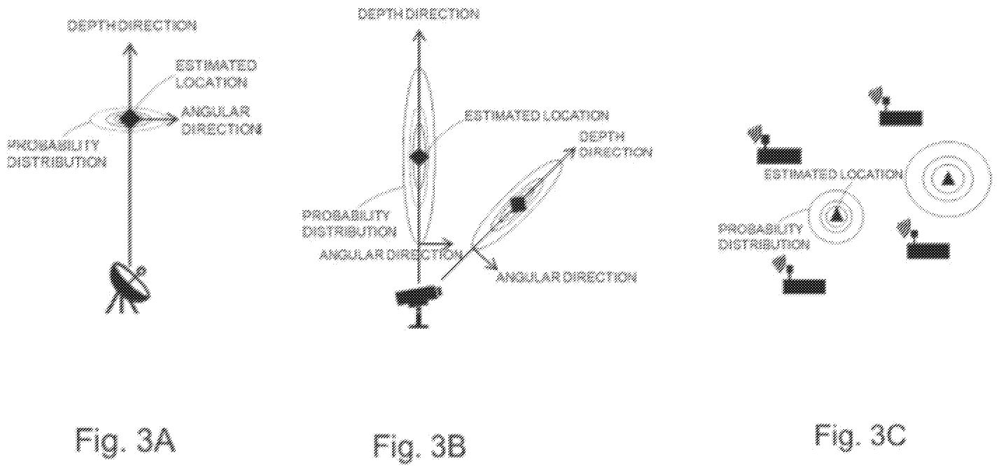

FIGS. 3A to 3C are diagrams illustrating examples of probability distribution in the location estimation processing for each of various sensors. FIG. 3A illustrates an example of probability distribution of location estimation in a radar, a laser, or the like. The radar has property that, as its characteristics, generally, reliability of location estimation in the depth direction (distance direction) is high, and reliability of location estimation in the angular direction (horizontal direction) is relatively low. Further, FIG. 3B illustrates an example of probability distribution at the time of location estimation in a camera. The camera has property that, as its characteristics, generally, reliability of location estimation in the angular direction is high, and reliability of location estimation in the depth direction is low. Note that, when the number of sensors is one regarding the radio wave sensor and the acoustic sensor, generally, probability distribution similar to the camera illustrated in FIG. 3B is obtained. In contrast, an example of probability distribution of location estimation in the radio wave sensor, the acoustic sensor, or the like when the number of sensors is three or more is illustrated in FIG. 3C. In this case, generally, there is property that as the number of sensors is increased probability distribution approaches the isotropic probability distribution, and there is also property that reliability thereof changes from moment to moment depending on the distance from each sensor to the emission source, transmission power (radio wave strength) of the emission source, and the like.

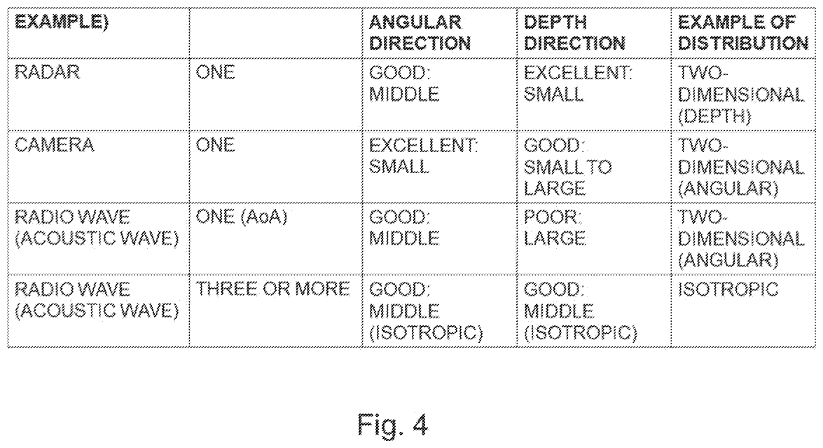

FIG. 4 is a diagram in which examples of the accuracy information (probability distribution and magnitude of errors) in the location estimation processing for each of the various sensors illustrated in FIG. 3 are compared and organized. Generally, the radar has a tendency to have two-dimensional probability distribution with high location reliability in the depth direction. In contrast, the camera has two-dimensional probability distribution with high location reliability in the angular direction. The same applies to the radio wave sensor and the acoustic sensor when the number of sensors is one. Further, in a case of three or more radio wave sensors and acoustic sensors, reliability of location estimation thereof has a tendency to have isotropic probability distribution. Here, although it depends on a physical distance from the sensor to the detected target, generally, the location estimation error (value of standard deviation or variance) in the radio wave sensor and the acoustic sensor has a tendency to be relatively larger than the location estimation error of the radar in the depth direction and the location estimation error of the camera in the angular direction.

Further, the parameter updating unit 33 of the radio wave detecting unit 30 learns and updates each parameter (propagation constant and the like) of the model (propagation model) of the propagation environment used for the location estimation processing in the first location estimating unit 32 by using the correct location information and the weighting information transmitted from the sensor fusion unit 50. The details of the method of learning and updating the parameters will be described later.

Next, the sensor fusion unit 50 performs processing of transmitting the correct location information and the weighting information for updating the parameters in the location estimation processing of the various sensor analyzing units and enhancing the location estimation accuracy by using the location information and its accuracy information of the target object input from the various sensor analyzing units. For example, by using the first location information and its accuracy information input from the radio wave detecting unit 30, the second location information and its accuracy information input from the image analyzing unit 40, and the like, association determination as to which target object and which target object are associated with each other among the target objects detected with each sensor (S5A) and calculation of the weighting value for the correct location information (S5D) are performed, and processing of transmitting the correct location information and its weighting information to the radio wave detecting unit 30 (S5D) is performed.

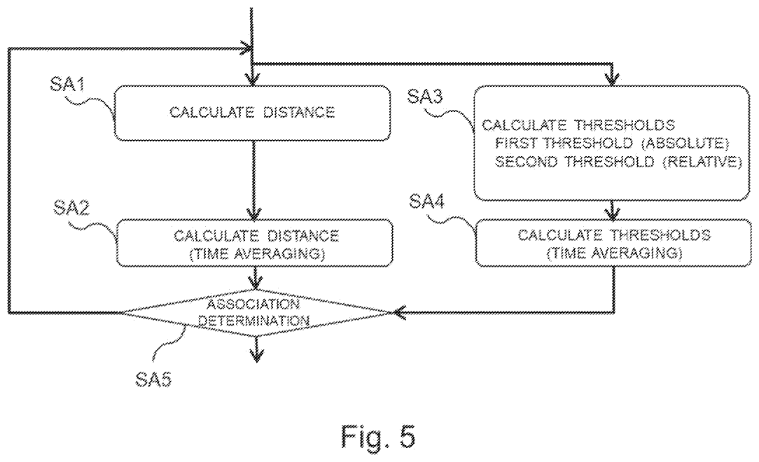

The details of each processing in the sensor fusion unit 50 will be described. First, association determination processing (identification determination, linkage determination) in the association determining unit 71 (SSA) will be described. FIG. 5 is a diagram illustrating an operation flow example of the association determination processing. First, the association determining unit 71 calculates each distance for each detected target by using the first location information from the radio wave detecting unit 30 and the second location information from the image analyzing unit 40 (SA1). Here, in preparation for a case in which the association determination processing is repeated without a condition of association being satisfied in the association determination processing to be described later, the calculated distance may be subjected to time averaging (SA2). Further, next, thresholds are calculated in order to dynamically change thresholds used for the association determination processing to be described later by using the accuracy information from various sensors such as the radio wave detecting unit 30 and the image analyzing unit 40 (SA3). Here, the example illustrated in FIG. 5 is an operation sequence in which threshold calculation processing is performed in parallel with distance calculation processing; however, an operation sequence in which the threshold calculation is performed after the distance calculation processing has no problem. Further, in the threshold calculation as well, in preparation for a case in which the association determination processing is repeated without a condition of association being satisfied in the association determination processing to be described later, the calculated thresholds may be subjected to time averaging (SA4).

Note that, in the threshold calculation processing (SA3), two types of thresholds are mainly calculated. For example, a distance from the location of a target object A1 estimated by the image analyzing unit 40 to a candidate point B2 estimated by the radio wave detecting unit 30 being located at the closest distance from the target object A1 is represented by D_{A1B2}. The thresholds include an absolute first threshold D_{TH1} specifying that the distance D_{A1B2} should be absolutely within a certain range, and a relative second threshold D_{TH2} specifying that a difference between the distance D_{A1B2} of the candidate point for the target object A1 and a distance D_{A1B1} of all of the other candidate points (second closest opposing point B1) for the target object A1 should be a certain distance or more. The absolute first threshold D_{TH1} is, for example, calculated based on standard deviation σ_{B2} of the candidate point, the absolute first threshold D_{TH1} being calculated as D_{TH1}=2σ_{B2}. Further, the relative second threshold D_{TH2} is, for example, calculated based on the sum of standard deviation σ_{B2} of the candidate point B2 and standard deviation σ_{B1} of the opposing point B1, the relative second threshold D_{TH2} being calculated as D_{TH2}=σ_{B2}+σ_{B1}.

By using the distance between the target objects calculated in the distance calculation processing (SA1) and the threshold calculated in the threshold calculation processing (SA3), the association determining unit 71 determines whether or not association can be performed (SA5: association determination processing). As described above, comparison between the distance D_{A1B2} of the candidate point B2 with respect to the target object A1 and the absolute first threshold D_{TH1} is performed, and as a determination condition of the absolute distance, whether or not D_{A1B2}≤D_{TH1} is satisfied is determined. Further, similarly, based on the difference between the distance D_{A1B2} of the candidate point B2 with respect to the target object A1 and the distance D_{A1B1} of the opposing point B1 with respect to the target object A1, comparison with the relative second threshold D_{TH2} is performed, and as a determination condition of the relative distance with other candidates, whether or not |D_{A1B1}−D_{A1B2}|≥D_{TH2} is satisfied is determined. Then, in the present example embodiment, when both of the determination conditions are satisfied, the candidate point B2 is considered to be identical with (associated with) the target object A1, and association determination results are thus output, whereas when any one thereof is not satisfied, association is considered to be impossible, and thus association determination is repeatedly performed again at the timing when the next location estimation results are obtained.

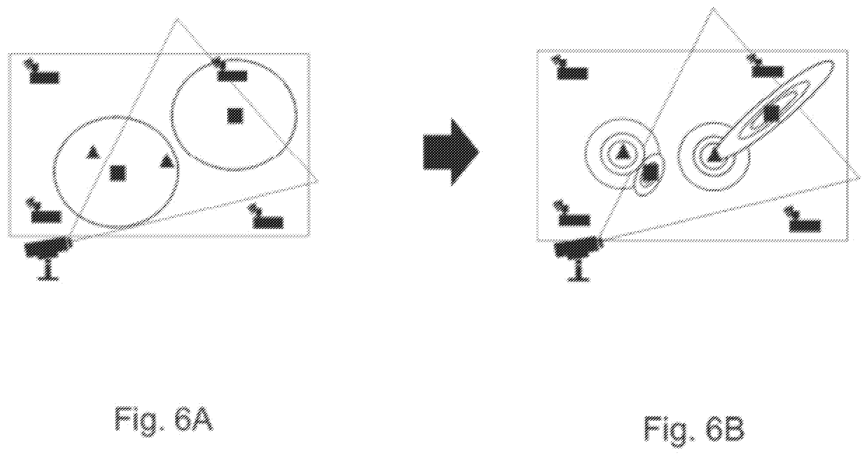

FIGS. 6A and 6B are diagrams illustrating advantages of the association determination processing by the association determining unit 71. When there are a plurality of detected targets in a close area such as within the angle of view of the camera, as a related method, in a case of a method of associating the closest targets, for example, a probability of wrong association is increased when the accuracy information of location estimation from each sensor is low, and when the location of such a wrongly associated target is transmitted as a correct value, the location estimation accuracy may be deteriorated on the contrary. Further, in a case of a method of not performing transmission when there are a plurality of detected targets or a method of performing transmission only when there is only one candidate within a certain distance (FIG. 6A), there are less opportunities for transmission, and the parameters cannot be learned smoothly. In contrast, according to the present example embodiment, by calculating a determination criterion (threshold) of association determination from the accuracy information of each sensor (the radio wave detecting unit 30 and the image analyzing unit 40), it can be determined that association is possible with high reliability by using an adaptive threshold, and therefore there are advantages that wrong association can be prevented and also learning of the parameters proceeds. For example, by calculating inclination of error distribution and the distance and the threshold also in consideration of directional axes as the accuracy information, as illustrated in FIG. 6B, it can be determined that there is only one whose error distribution overlaps, and therefore association with high reliability is enabled.

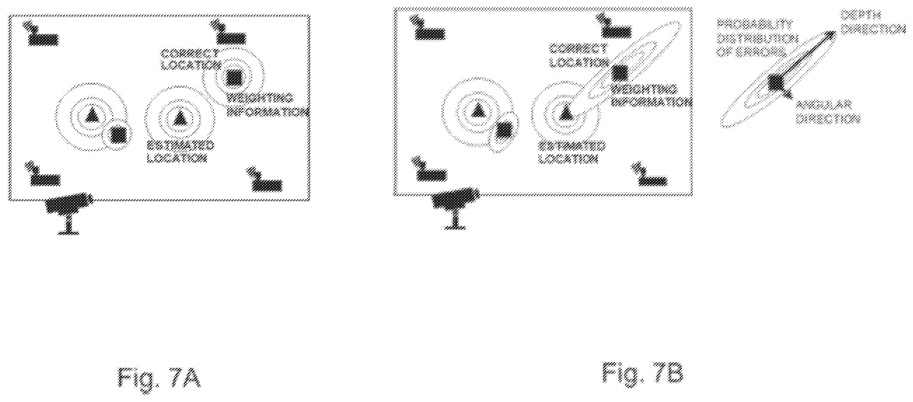

Next, the weight calculation processing (S5D) in the weight calculating unit 72 will be described. FIGS. 7A and 7B are diagrams illustrating examples of weight calculation in the weight calculating unit 72. First, the weight calculating unit 72 selects probability distribution of location estimation in each sensor by using the accuracy information of the sensors (image analyzing unit 40 and the like) that detect the correct location of the target object. For example, as illustrated in FIGS. 3A to 3C or FIG. 4, in a case of the image analyzing unit 40 in which a target sensor uses the camera 41, two-dimensional probability distribution having high location reliability in the angular direction is selected, while in a case of the radio wave detecting unit 30 in which the target sensor uses three or more radio wave sensors 31, isotropic probability distribution is selected. Then, for example, in the case of the image analyzing unit 40 in which the target sensor uses the camera 41, as illustrated in FIG. 7A, regardless of the probability distribution of the target sensor, error circles are assumed to be isotropic (one-dimensional), and a value (standard deviation σ and an average value thereof, a multiple 2σ or 3σ thereof, or the like) corresponding to the radius of the error circle is calculated as the weighting value. Alternatively, as illustrated in FIG. 7B, when the probability distribution of the target sensor is two-dimensional, inclination information of the axis of an ellipse being an error circle and a value (two-dimensional standard deviation σ and an average value thereof, a multiple 2σ or 3σ thereof, or the like) corresponding to the radius of each of the axes of the angular direction and the depth direction are calculated as the weighting values.

Finally, the weighting determining unit 70 transmits the correct location information and the weighting information for each target object detected with various sensor units such as the radio wave detecting unit 30 to the sensor units (the radio wave detecting unit 30 and the like), based on association results from the association determining unit 71 and the weighting value from the weight calculating unit 72. For example, when the association determining unit 71 determines that the target object A1 detected in the image analyzing unit 40 can be associated with a target object B2 detected in the radio wave detecting unit 30, the association determining unit 71 transmits the location estimation information of the target object A1 input from the image analyzing unit 40 and the weighting value for the target object A1 calculated in the weight calculating unit 72 as the correct location information and the weighting information for the target object B2. Further, when none of the target objects detected in the image analyzing unit 40 can be associated with a certain target object B2 detected in the radio wave detecting unit 30, the correct location information is transmitted as “none”, or the weighting information is transmitted as zero (no weight).

Next, the details of the operation of the parameter updating unit 33 in the radio wave detecting unit 30 will be described. The parameter updating unit 33 learns and updates each parameter (propagation constant and the like) of the model (propagation model) of the propagation environment used for the location estimation processing in the first location estimating unit 32 by using the correct location information and the weighting information transmitted from the sensor fusion unit 50 (S3D).

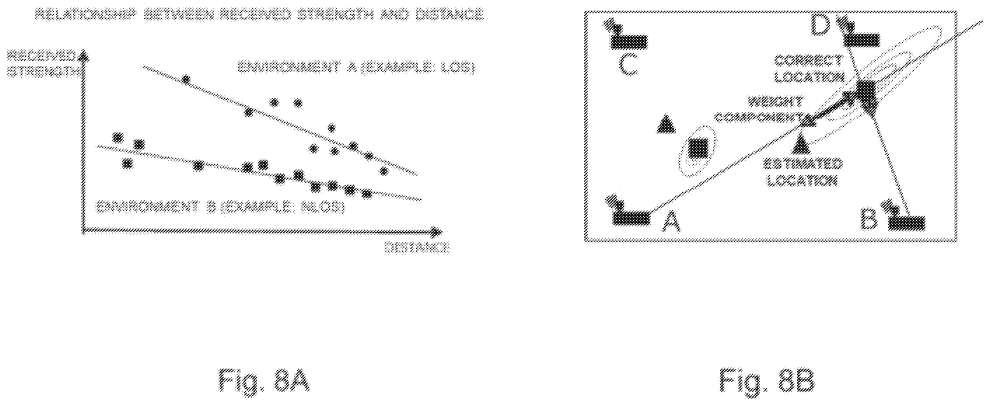

FIGS. 8A and 8B are diagrams illustrating operation examples of learning and updating of parameters in the parameter updating unit 33. In the example illustrated in FIGS. 8A and 8B, the parameter updating unit 33 calculates propagation constants in the propagation model used for the location estimation processing as parameters. In the present example, the propagation model as illustrated in the following equations are used. A propagation constant α is a parameter related to transmission output of radio waves in general, and β is a parameter related to an attenuation rate in a unit distance. dₙ(φ) is a distance between a radio wave sensor n and an emission source, φ=(x, y, z) is location coordinates of a radio wave emission source, and (xₙ₁, xₙ₂, xₙ₃) is location coordinates of the radio wave sensor n. In an environment in which the radio wave sensor is arranged, when radio waves emitted from the radio wave emission source with its location being known are received with each radio wave sensor, the graph of FIG. 8A is obtained. Here, Line of Sight (LOS) in FIG. 8A signifies points and a propagation model in a line of sight environment, and Non Line of Sight (NLOS) signifies points and a propagation model in a non line of sight environment. When values of measured received strength and a distance between the emission source and the radio wave sensor are fit to the following equations by using the least squares method, the maximum likelihood estimation method, or the like, the propagation constants (α, β) are obtained. Note that the first location estimating unit 32 estimates the location of the radio wave emission source after estimating the distance from each radio wave sensor to the radio wave emission source by using the following equations including the propagation constants (α, β), based on the received strength information received by each radio wave sensor from the radio wave emission source. Thus, to learn and update the propagation constants (α, β) in accordance with the environment is important.

\tilde{m}ₙ(ϕ)=α·dₙ(ϕ)^{-β}

dₙ(ϕ)=\sqrt{(x−xₙ₁)²+(y−xₙ₂)²+(z−xₙ₃)²} [Math. 1]

Here, by using the correct location information and its weighting information transmitted from the sensor fusion unit 50 for any detected target, the parameter updating unit 33 plots points corresponding to the correct location information on the graph of FIG. 8A. Specifically, the points can be plotted from the received radio wave strength received by each radio wave sensor when the target object is detected and the information of the distance from the transmitted correct location to the radio wave sensor. In addition, in this case, a weight is applied to each point at the time of fitting to the above equations using the least squares method or the like at parameter updating timing.

Specifically, when the weighting information transmitted from the sensor fusion unit 50 is a one-dimensional weighting value as illustrated in FIG. 7A, a value according to the weighting information is simply used as the weight. For example, when the weighting value is the radius of the error circle (standard deviation or the like), a smaller weight is used as the weighting value is larger, such as by using a reciprocal of the weighting value or a difference obtained by subtracting the weighting value from the maximum value as the weight. In contrast, when the weighting information is the inclination in the two-dimensional error circle and the radius in each axis (standard deviation or the like) as illustrated in FIG. 7B, the weight is calculated as illustrated in FIG. 8B. Specifically, according to the direction from each radio wave sensor to the correct location coordinates, based on error distribution (inclination of an ellipse, the radius of a long axis, a radius of a short axis) obtained from the weighting information, a weight component (intersection between the ellipse and the directional axis or the like) corresponding to the direction is calculated. For example, in the example illustrated in FIG. 8B, the weight component of the correct location information for a radio wave sensor A is larger than the weight component for a radio wave sensor B. A reciprocal of the weight component different for each radio wave sensor or a difference obtained by subtracting the weight component from the maximum value is used as the weight. By performing fitting to above Math. 1 or the like once every certain time or once every certain number of plotting, the parameters such as the propagation constants (α, β) are dynamically updated.

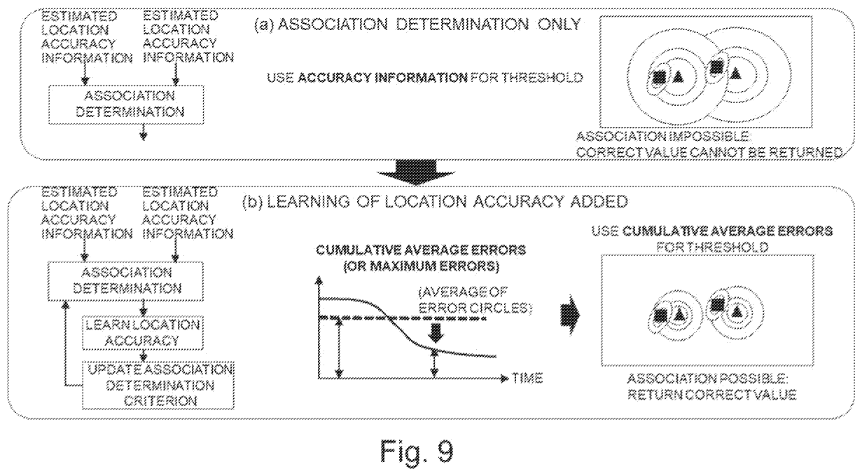

Further, finally, learning processing of the location accuracy (S5B) and updating of an association determination criterion (S5C) in the location accuracy learning unit 73 of the sensor fusion unit 50 will be described. FIG. 9 is a diagram illustrating operation of learning of the location accuracy and updating of the association determination criterion in the location accuracy learning unit 73.

First, as a premise, when the learning and the parameter updating in the parameter updating unit 33 proceed well, the accuracy of the location estimation in various sensor units such as the radio wave detecting unit 30 is enhanced. Specifically, results of the location estimation become closer to the correct location. However, the accuracy information output from the first location estimating unit 32 is a value corresponding to standard deviation or the like obtained from probability distribution of errors (joint likelihood information) or the like, and thus the enhancement of the location estimation accuracy may not be directly reflected in the accuracy information. In this case, as illustrated in the upper part (a) of FIG. 9, with only the association determination processing (S5A) in the association determining unit 71 described above, the association determination criterion is calculated using only input accuracy information. Thus, even when the location estimation accuracy is enhanced, the enhancement is not reflected in the association determination criterion. As a result, even when association is made possible when the location accuracy enhancement is taken into consideration, association may be considered impossible, and transmission may not be performed.

In view of this, as illustrated in the lower part (B) of FIG. 9, in the location accuracy learning unit 73, the learning of the location accuracy and the updating of the association determination criterion are performed. Regarding the learning of the location accuracy (S5B), first, the maximum errors within a certain period (or once every certain number of samples) or cumulative average errors within a certain period (or a value corresponding to a value of 90% of the errors) are calculated by using the location estimation results and the correct location information determined as association possible in the association determining unit 71. Then, the transition of the maximum errors or the cumulative average errors is plotted once every certain period or once every certain number of samples, and gradual convergence (gradual decrease) is confirmed. Specifically, a convergence degree of the location estimation accuracy is learned. In addition, in the updating of the association determination criterion (S5C), when it can be confirmed that the above is gradually converging and that its value is smaller than the radius of the error circle or the like input as the accuracy information, the association determination criterion is calculated based not on the accuracy information but on the value (the maximum errors or the average errors). Specifically, the association determination criterion is dynamically changed by using not only the accuracy information but also the convergence degree of the location estimation accuracy. With this configuration, the enhancement of the location estimation accuracy is reflected in the association determination criterion, and thus association determination with high reliability is enabled.

Further, as described above, when it is determined by the association determining unit 71 that the target objects detected in various sensors such as the radio wave detecting unit 30 and the image analyzing unit 40 are associated with each other (identical), the sensor fusion unit 50 integrates the location estimation information of the targets from each sensor analyzing unit in the location information integrating unit 74, and thus accuracy of the location of the targets may be further enhanced. As an integration method of the location estimation information, for example, based on the accuracy information (probability distribution, standard deviation, or the like) of the location estimation of the target objects output from the radio wave detecting unit 30 and the image analyzing unit 40, a method of integration using joint probability distribution, in which both the probability distributions are joined with their reliability being likelihood, is used. Alternatively, the following method may be used: for the location estimation results output from the radio wave detecting unit 30 and the image analyzing unit 40, based on each piece of accuracy information (standard deviation, variance, or the like), averaging (weighted average) is performed with the weight being its reliability. Further, accuracy of the identification information of the targets may be further enhanced by integrating the identification information of the targets from each sensor analyzing unit in the identification information integrating unit 75 with a similar method.

In this manner, in the first example embodiment, when various sensor units such as the radio wave detecting unit 30 include the first location estimating unit 32 and the parameter updating unit 33 for the location estimation processing, the location estimation accuracy can be enhanced. In particular, when the sensor fusion unit 50 includes the association determining unit 71 that determines association between the target objects from the first location information and the second location information, transmission of wrong location estimation results of the target objects can be prevented. Further, when the sensor fusion unit 50 includes the weight calculating unit 72 that calculates the weighting value from the accuracy information of the second location information and the sensor fusion unit 50 transmits the weighting information together with the correct location information to the parameter updating unit 33, the parameter updating unit 33 can perform parameter updating with higher reliability. In addition, when the sensor fusion unit 50 includes the location accuracy learning unit 73 that learns the location estimation accuracy and dynamically changes the association determination criterion in the association determining unit 71 from its convergence degree, there are advantages that association determination can be performed with the enhancement of the location accuracy being reflected, and as a result, location estimation accuracy can be enhanced more effectively.

### 3. Second Example Embodiment

(1) Configuration

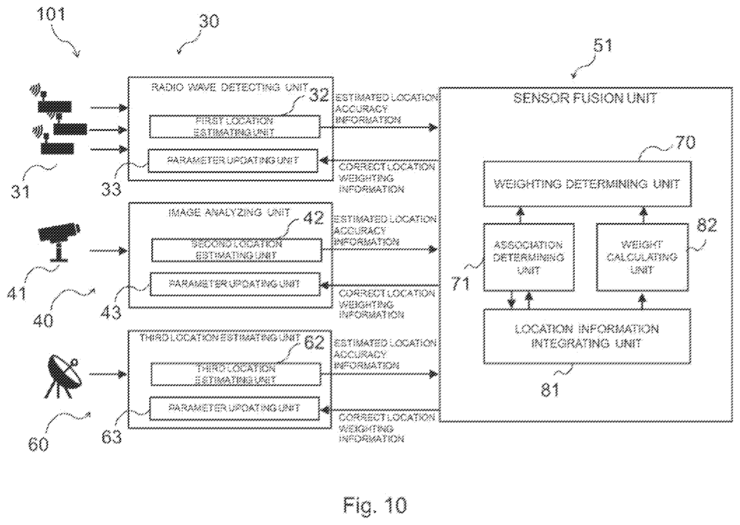

FIG. 10 is a diagram illustrating an overall configuration of a location estimation system 101 according to the second example embodiment of the present invention. The location estimation system 101 according to the second example embodiment assumes that there is a location estimation error in each of various sensor analyzing units such as the radio wave detecting unit 30 and the image analyzing unit 40, and learns and updates parameters in each of the sensor analyzing units with an estimated location obtained by integrating their location estimation results being used as a correct location. Further, the second example embodiment takes an example of integration of sensor information in which a radar analyzing unit 60 also exists in addition to the radio wave detecting unit 30 and the image analyzing unit 40.

The location estimation system 101 that integrates the sensor information according to the second example embodiment includes, similarly to the first example embodiment, various sensor analyzing units (the radio wave detecting unit 30, the image analyzing unit 40, the radar analyzing unit 60, and the like) and a sensor fusion unit 51. Here, the radio wave detecting unit 30 includes, similarly to the first example embodiment, the one or the plurality of radio wave sensors 31, the first location estimating unit 32, and the parameter updating unit 33. Further, the image analyzing unit 40 includes, in addition to the one or the plurality of cameras 41 and the second location estimating unit 42, a parameter updating unit 43 as a configuration specific to the second example embodiment. The radar analyzing unit 60 includes one or a plurality of radars 61, a third location estimating unit 62, and a parameter updating unit 63. Note that, although not illustrated in the figure, various laser (LiDAR) analyzing units, acoustic sensor analyzing units, or the like may be included as examples of other sensor analyzing units.

Here, the parameter updating unit 43 in the image analyzing unit 40 being specific to the second example embodiment learns and updates environmental parameters when coordinate conversion is performed from a pixel location (an image or coordinates {x, y} on the image) of a target detected on a camera image into physical world coordinates ({x, y, z}, {latitude, longitude, altitude} on a map or the like), for example, a coordinate conversion matrix, a camera calibration parameter, and a set value such as a height and a stature of the detected target.

Further, in the radar analyzing unit 60, for example, with the use of transmission and reception radio wave information by various radars, the third location estimating unit 62 identifies location estimation (mainly, distance measurement) of a target object, and outputs the location estimation information and the identification information. In this case, the accuracy information (probability distribution of errors, standard deviation, or the like) in the location estimation processing is calculated and output as well. Then, the parameter updating unit 63 learns and updates environmental parameters used at the time of location estimation (distance estimation) in the third location estimating unit 62, for example, speed of radar waves and its attenuation rate or the like.

Further, the sensor fusion unit 51 integrates the location information, the accuracy information, the identification information, and the like from the radio wave detecting unit 30, the image analyzing unit 40, the radar analyzing unit 60, and the like to achieve high accuracy, and also makes the correct location information and the weighting information various sensor analyzing units. Specifically, similarly to the first example embodiment, the association determining unit 71, a weight calculating unit 82, and the weighting determining unit 70 are included, and also a location information integrating unit 81 that integrates location estimation results from various sensor analyzing units is included. Further, in addition, an identification information integrating unit that integrates the identification information from various sensor analyzing units and the like may be included. Here, the weighting determining unit 70 and the association determining unit 71 are basically substantially similar to those of the first example embodiment, and the weight calculating unit 82 performs operation specific to the second example embodiment by using results of the location information integrating unit 81 specific to the second example embodiment.

(2) Operation

Next, operation of the second example embodiment will be described.

As the operation of the second example embodiment according to the present invention, as illustrated in FIG. 10, first, detection and identification of target objects and the location estimation processing of the target objects are performed in various sensor analyzing units such as the radio wave detecting unit 30, the image analyzing unit 40, and the radar analyzing unit 60. For example, the radar analyzing unit 60 detects and identifies target objects by using the transmission and reception radio wave information by various radars, and performs location estimation (mainly, distance measurement) of the targets by the third location estimating unit 62.

Here, at the time of the location estimation processing of the targets in each sensor analyzing unit, the accuracy information of location estimation is calculated in the first location estimating unit 32, the second location estimating unit 42, and the third location estimating unit 62. Examples of the accuracy information include, as illustrated in FIGS. 3A to 3C and FIG. 4, probability distribution of location estimation likelihood (two-dimensional Gaussian distribution, isotropic Gaussian distribution, normal distribution, or the like), standard deviation and variance thereof, and the like.

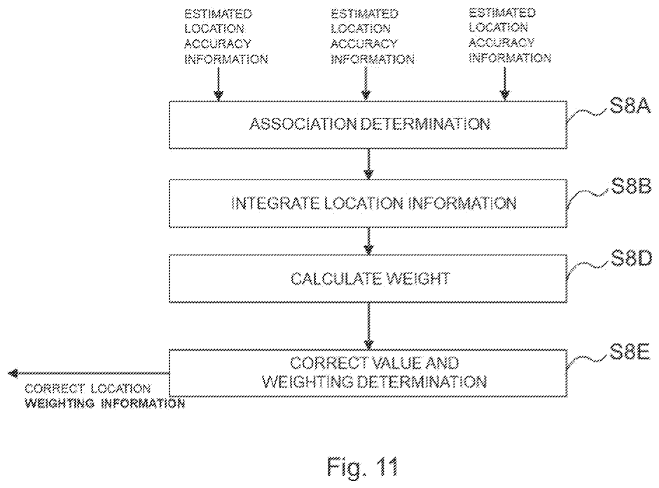

Next, operation of the sensor fusion unit 51 according to the second example embodiment will be described. FIG. 11 is a diagram illustrating an example of operation of the sensor fusion unit 51 according to the second example embodiment.

By using the identification information, the location estimation information, the accuracy information of location estimation (probability distribution, standard deviation, or the like) output from various sensor analyzing units such as the radio wave detecting unit 30, the image analyzing unit 40, and the radar analyzing unit 60, similarly to the first example embodiment, first, the sensor fusion unit 51 performs association determination (identification determination, linkage determination) as to which target object and which target object are associated with each other among the target objects detected in the various sensors in the association determining unit 71 (S8A).

Then, when it is determined that the targets detected in a plurality of sensor analyzing units are identical (associated with each other) through the association determination by the association determining unit 71, as the operation specific to the second example embodiment, the location estimation information of the targets from each sensor analyzing unit is integrated in the location information integrating unit 81 to achieve high accuracy of the estimated location of the target objects (S8B). Note that, by using the association determination results, similarly, the identification information of the targets from each sensor analyzing unit may be integrated by an identification information integrating unit (not illustrated) to achieve high accuracy of the identification information of the targets.

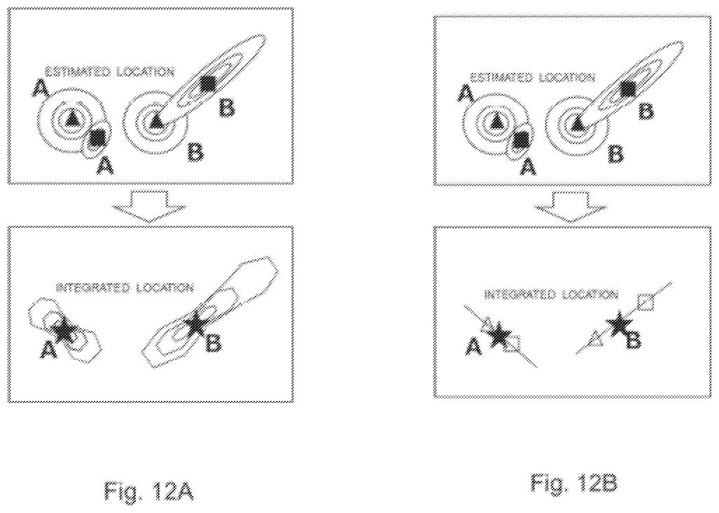

FIGS. 12A and 12B are diagrams illustrating examples of operation of the location information integrating unit 81 in the sensor fusion unit 51. As an integration method of the location estimation information in the location information integrating unit 81, for example, as illustrated in FIG. 12A, based on the accuracy information (probability distribution, standard deviation, or the like) of the location estimation of the target objects output from the radio wave detecting unit 30 and the image analyzing unit 40, a method of integration using joint probability distribution, in which both the probability distributions are joined with their reliability being likelihood, is used. A point (location coordinates) having the highest likelihood in the joint probability distribution (joint likelihood) is output as an integrated estimated location. Alternatively, as illustrated in FIG. 12B, the following method may be used: for the location estimation results output from the radio wave detecting unit 30 and the image analyzing unit 40, based on each piece of accuracy information (standard deviation, variance, or the like), averaging (weighted average) is performed with the weight being its reliability. In this case, for example, by taking an example of a case in which it is determined that the detected target objects of two sensors are identical (associated with each other), the integrated location can be calculated according to an equation expressed as: {integrated location}={{first location estimation results}×{relative reliability of first location estimation results}}+{{second location estimation results}×{relative reliability of second location estimation results}}. Here, {relative reliability of x-th location estimation results} is such a value that 1 is obtained when all of the reliabilities of x various sensors are added up, and in a case of the present example, the value is a value that can be calculated by {relative reliability of first location estimation results}={normalized first accuracy information}/{{normalized first accuracy information}+{normalized second accuracy information}}, and that is equal to {relative reliability of second location estimation results}={1−relative reliability of first location estimation results}. Alternatively, although not illustrated in the figure, as a calculation method of the integrated location other than the above, there is a method of directly adopting, among the location estimation results from various associated sensors, the location estimation results having the highest reliability from their accuracy information as the integrated location.

In addition, the sensor fusion unit 51 according to the second example embodiment transmits the integrated location in the location information integrating unit 81 as the correct location in the weighting determining unit 70, and also calculates and transmits its weighting information by the weight calculating unit 82 (S8D). Similarly to the location information integrating unit 81, the weight calculating unit 82 integrates the accuracy information in location estimation from various sensor units, and thereby calculates weighting information for the correct location. For example, when the location information integrating unit 81 estimates the integrated location by using joint probability distribution (joint likelihood) as illustrated in FIG. 12A, information of the joint probability distribution may be directly transmitted as the weighting information, and a value corresponding to standard deviation or variance may be calculated from the joint probability distribution (joint likelihood) and the value may be transmitted. In the latter case, when a value corresponding to standard deviation is transmitted as the radius in the form of approximating the joint probability distribution to an isotropic error circle, one-dimensional value is obtained. Further, when the joint probability distribution is transmitted as a value corresponding to its standard deviation in the form of approximating the joint probability distribution to a two-dimensional error circle (ellipse), the weighting information has a value corresponding to inclination of the ellipse and the standard deviation of each axis.

In contrast, when each reliability is weighted and averaged based on each piece of accuracy information and the integrated location is calculated as illustrated in FIG. 12B in the location information integrating unit 81, the accuracy information of the integrated location may be calculated as the weighting information and transmitted. For example, when the accuracy information for the location estimation results having the highest reliability among the location estimation results from various associated sensors is represented by {accuracy information for first location estimation results}, the weighting information is calculated as: {accuracy information for first location estimation results}×{relative reliability of first location estimation results}. Here, for example, {relative reliability of first location estimation results}={normalized first accuracy information}/{{normalized first accuracy information}+{normalized second accuracy information}}. Alternatively, in the location information integrating unit 81, in consideration of the fact there is a case in which the location estimation results having the highest reliability from the accuracy information among the location estimation results from various associated sensors are directly adopted as the integrated location, the accuracy information for the location estimation results having the highest reliability may also be directly transmitted as the weighting information. This case is substantially similar to the weight calculation method described with reference to FIGS. 7A and 7B and the like in the first example embodiment.

Finally, in the weighting determining unit 70, based on the association results from the association determining unit 71, the integrated location from the location information integrating unit 81, and the weighting information from the weight calculating unit 82, similarly to the first example embodiment, the correct location information and the weighting information for each target object detected in various sensor units (the radio wave detecting unit 30, the image analyzing unit 40, the radar analyzing unit 60, and the like) are transmitted to the sensor units. Here, as the operation specific to the second example embodiment, the location estimation results integrated in the location information integrating unit 81 are transmitted as the correct location information, and the weighting information calculated in the weight calculating unit 82 according to the second example embodiment is transmitted as the weighting information. Note that, when none of the target objects detected in other sensor analyzing units can be associated with any target object detected with any sensor, the correct location information is transmitted as “none”, or the weighting information is transmitted as zero (no weight).

Next, details of operation of the parameter updating units 33, 43, and 63 in various sensor analyzing units (the radio wave detecting unit 30, the image analyzing unit 40, the radar analyzing unit 60, and the like) according to the second example embodiment will be described.

Similarly to the first example embodiment, the parameter updating unit 33 in the radio wave detecting unit 30 learns and updates each parameter (propagation constant and the like) of the model (propagation model) of the propagation environment used for the location estimation processing in the first location estimating unit 32 by using the correct location information and the weighting information transmitted from the sensor fusion unit 50. Basically, the operation is similar to the operation described with reference to FIGS. 8A and 8B and FIGS. 7A and 7B according to the first example embodiment, and when the weighting information transmitted from the sensor fusion unit 51 is one-dimensional weighting value as illustrated in FIG. 7A, a value according to the weighting information is simply used as the weight. Then, when the weighting information is two-dimensional information as illustrated in FIG. 7B as well, as described with reference to FIG. 8B in the first example embodiment, each parameter is learned and updated by using the inclination and the value of the weighting value (standard deviation or the like) in each axis, with the weight component from each sensor being calculated and a value according to the weight component being used as the weight. Further, as the operation specific to the second example embodiment, when the information of the joint probability distribution is directly transmitted as the weighting information from the sensor fusion unit 51, the value corresponding to standard deviation or variance is calculated from the joint probability distribution (joint likelihood) and the value is used as the weight. Next, when the value corresponding to standard deviation or variance of the joint probability distribution (joint likelihood) is transmitted, the weight is used with a method similar to that of the first example embodiment, with the value being used as a one-dimensional weighting value. Further, when the value (value corresponding to inclination of the ellipse and the standard deviation of each axis) corresponding to the standard deviation in the form of approximating the joint probability distribution to the two-dimensional error circle (ellipse) is transmitted as the weighting information, the weight is used with a method similar to that of the first example embodiment with the value being used as a two-dimensional weighting value. In addition, when the accuracy information of the integrated location is transmitted as the weighting information as well, the weight is used with a method similar to that of the first example embodiment, with the value being used as a one-dimensional weighting value.

Next, similarly to the parameter updating unit 33 of the radio wave detecting unit 30, the parameter updating unit 43 of the image analyzing unit 40 learns and updates parameters for coordinate conversion by using the correct location information and the weighting information transmitted from the sensor fusion unit 51. Specifically, environmental parameters when coordinate conversion is performed from a pixel location (an image or coordinates {x, y} on the image) of a target object detected on a camera image into physical world coordinates ({x, y, z}, {latitude, longitude, altitude} on a map or the like), for example, a coordinate conversion matrix, a camera calibration parameter, and a set value such as a height and a stature of the detected target, are learned and updated.

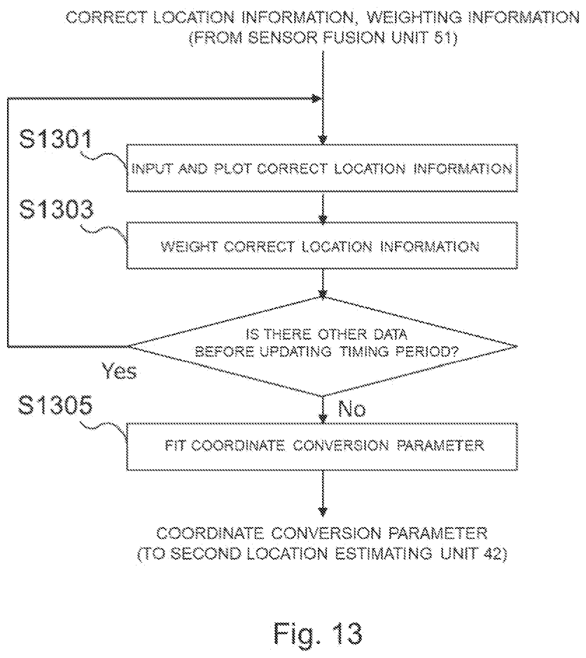

FIG. 13 is a diagram illustrating an example of an operation flow of the parameter updating units 33, 43, and 63 in various sensor units. For example, generally, the parameter updating unit 43 of the image analyzing unit 40 performs camera calibration, and calculates coordinate conversion parameters. In this case, two types of information (correct values) before the coordinate conversion and after the coordinate conversion, such as where in the physical world coordinates the pixel location on the camera image is associated, are input and plotted in combination (S1301). Here, generally, matrix parameters for coordinate conversion are calculated after information related to a plurality of pixel locations are input and plotted. As illustrated in FIG. 13, the parameter updating unit 43 calculates the weight with a method similar to that of the parameter updating unit 33 in the radio wave detecting unit 30 by using the weighting information for the correct location information transmitted from the sensor fusion unit 51 (S1303), and applies the weight to each piece of correct location information and fits the coordinate conversion parameter (S1305). With this configuration, the correct value having higher reliability has greater influence on the fitting, whereas the correct value having low reliability has less influence.

Further, regarding the parameter updating unit 63 in the radar analyzing unit 60 as well, operation similar to that of other parameter updating units 33 and 43 described above is performed. Note that the parameter updating unit 63 learns and updates environmental parameters used at the time of location estimation (distance estimation) in the third location estimating unit 62, for example, speed of radar waves and its attenuation rate or the like. Specifically, the parameter updating unit 63 calculates the weight with a method similar to that of other parameter updating units 33 and 43 by using the weighting information for the correct location information transmitted from the sensor fusion unit 51, applies the weight to each piece of correct location information, and then fits the environmental parameter at the time of distance estimation.

In this manner, according to the second example embodiment, when the parameter updating units 33, 43, and 63 for the location estimation processing are included together with the first location estimating unit 32, the second location estimating unit 42, and the third location estimating unit 62 in various sensor analyzing units such as the radio wave detecting unit 30, the image analyzing unit 40, and the radar analyzing unit 60, the location estimation accuracy can be enhanced. In particular, similarly to the first example embodiment, when the sensor fusion unit 51 includes the association determining unit 71 that determines association between the detected targets from each sensor analyzing unit, transmission of wrong location estimation results of the targets can be prevented.

Here, effects specific to the second example embodiment are that, even when each sensor analyzing unit has a location estimation error regardless of a type of the sensor analyzing unit, the location estimation accuracy of each sensor analyzing unit can be effectively enhanced. This is because a more general-purpose location estimation system is used, in which it is assumed that there is a location estimation error in each of various sensor analyzing units such as the radio wave detecting unit 30, the image analyzing unit 40, and the radar analyzing unit 60, and the correct location having higher reliability is estimated as the integrated location, and the environmental parameters are learned and updated in each of the sensor analyzing units. In addition, as a result, there are advantages that estimation accuracy of the integrated location in which the location estimation results from various sensor analyzing unit are integrated is also synergistically enhanced.

Further, the first example embodiment and the second example embodiment are mainly described by taking an example of two-dimensional location coordinates (plain coordinates). However, a location estimation system and a location estimation method in which the sensor information is integrated can also be extended to three-dimensional location coordinates (spatial coordinates) as well.

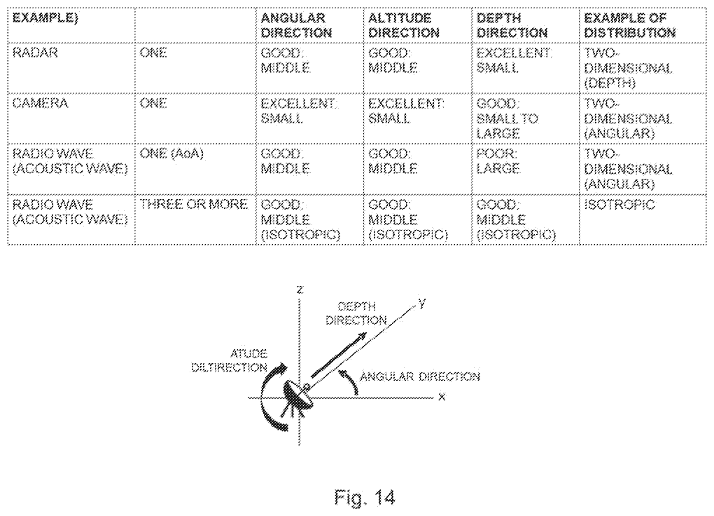

FIG. 14 is a diagram in which examples of the accuracy information (probability distribution and magnitude of errors) in the location estimation processing for each of the various sensors are compared and organized in a case of extending the method of the present example embodiment to a three-dimensional space. Generally, the radar has a tendency to have three-dimensional probability distribution with high location reliability in the depth direction. In contrast, the camera has three-dimensional probability distribution with high location reliability in the angular direction and the altitude direction. The same applies to the radio wave sensor and the acoustic sensor when the number of sensors is one. Further, in a case of three or more radio wave sensors and acoustic sensors, reliability of location estimation thereof has a tendency to have isotropic probability distribution in the three-dimensional space. Here, although it depends on a physical distance from the sensor to the detected target, generally, the location estimation error (value of standard deviation or variance) in the radio wave sensor and the acoustic sensor has a tendency to be relatively larger than the location estimation error of the radar in the depth direction and the location estimation error of the camera in the angular direction and the altitude direction. Further, the accuracy information (value of standard deviation or variance) of the location estimation of individual targets in the various sensors has property to change from moment to moment every time location estimation is performed.

Note that, in a case of extension to the three-dimensional space, in various sensor analyzing units, the processing of each location estimating unit and the like is extended to processing for the three-dimensional space, and further, in each of the sensor fusion units 50 and 51, the processing of the association determining unit 71, the weight calculating units 72 and 82, the location accuracy learning unit 73, the location information integrating unit 81, and the like is extended to processing for the three-dimensional space. In this case, the extension to the three-dimensional space is possible by using the three-dimensional accuracy information (probability distribution and magnitude of errors) illustrated in FIG. 14 instead of FIG. 4. Specifically, a basic method is similar to the method described in the first example embodiment and the second example embodiment, and the three-dimensional space can also be easily coped with by extending the calculation processing or the like of the weighting value for each directional axis for the three-dimensional space by using FIG. 14, for example.

### 4. Third Example Embodiment

Next, with reference to FIG. 13, the third example embodiment of the present invention will be described. The above-described first example embodiment and second example embodiment are concrete example embodiments, whereas the third example embodiment is a more generalized example embodiment.

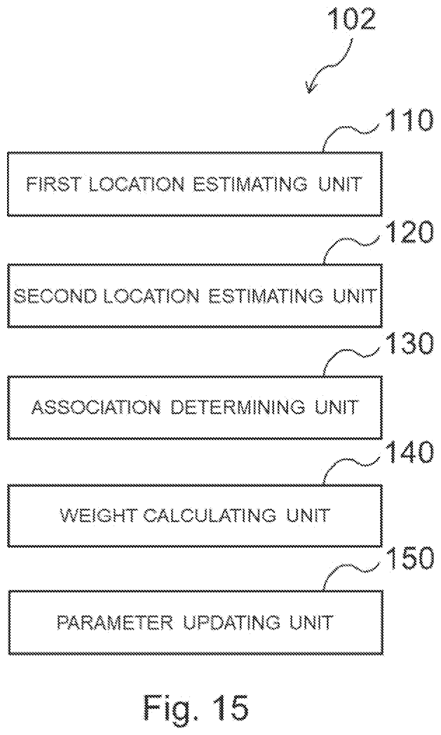

With reference to FIG. 15, an example of a configuration of a location estimation system 102 according to the third example embodiment will be described. FIG. 15 is a block diagram illustrating an example of a schematic configuration of the location estimation system 102 according to the third example embodiment. With reference to FIG. 15, the location estimation system 102 includes a first location estimating unit 110, a second location estimating unit 120, an association determining unit 130, a weight calculating unit 140, and a parameter updating unit 150.

According to the location estimation system 102 consisting of the configuration as described above, the first location estimating unit 110 estimates first location information related to a target object. The second location estimating unit 120 estimates second location information related to a target object. The association determining unit 130 determines association between the target object whose location is estimated from the first location information and the target object whose location is estimated from the second location information, based on the first location information and the second location information. The weight calculating unit 140 calculates correct location information of the target object and weighting information of the correct location information, based on accuracy information of the second location information and determination results of the association. The parameter updating unit 150 updates a parameter for estimating the first location information, based on the correct location information and the weighting information.

For example, the first location estimating unit 110 may perform operation of the first location estimating unit 32 according to the first example embodiment or the second example embodiment described above. The second location estimating unit 120 may perform operation of the second location estimating unit 42 according to the first example embodiment or the second example embodiment described above. The association determining unit 130 may perform operation of the association determining unit 71 according to the first example embodiment or the second example embodiment described above. The weight calculating unit 140 may perform operation of the weight calculating units 72 and 82 according to the first example embodiment or the second example embodiment described above. The parameter updating unit 150 may perform operation of the parameter updating unit 33 according to the first example embodiment or the second example embodiment described above.

### 5. Effects of Example Embodiments

According to the example embodiments described above, the following effects can be expected.

The first effect is that the targets detected with various sensors such as the radio wave detecting unit, the image analyzing unit, and the radar analyzing unit can be associated (identified, linked) with high reliability. With this, learning and updating processing of the environmental parameters necessary for the location estimation processing can be performed with high reliability. Specifically, the location estimation accuracy can be efficiently enhanced. The reason is that, in the association determining unit in the sensor fusion unit, by dynamically changing the association determination criterion using the accuracy information at the time of location estimation in various sensors such as the radio wave detecting unit and the image analyzing unit and then determining association using the determination criterion, association determination between the detected targets can be performed adaptively (with high reliability and in a short period of time) in accordance with the location estimation errors (accuracy information) from the various sensors. This brings advantages that returning of a wrong location of a target as a correct value, which is the first factor of deterioration of the location estimation accuracy, can be prevented, and more correct values with high reliability that are necessary for learning can be transmitted.

The second effect is that, in various sensor analyzing units such as the radio wave detecting unit, the image analyzing unit, and the radar analyzing unit, by using not only the correct location information but also its weighting information as well, the learning and updating processing of the environmental parameters necessary for the location estimation processing can be performed with higher reliability in accordance with the reliability of the correct location information. As a result, the accuracy of location estimation can also be effectively enhanced. One reason is that the sensor fusion unit described above includes a weight calculation means for dynamically calculating the weighting information of the correct location information, based on the probability distribution model and the like included in the accuracy information at the time of location estimation in various sensor analyzing units such as the radio wave detecting unit and the image analyzing unit. Another reason is that, owing to the above configuration, in a parameter updating means in the various sensor units, the weight of the correct location having high accuracy information (small errors) is increased, and the weight of the correct location having low accuracy information (large errors) is reduced, such that the learning and updating processing of the parameters can be performed with high reliability and effectively.

Further, the first example embodiment described above brings advantages that the directional axis having high accuracy information (small errors) and the directional axis having low accuracy information (large errors) are separated, and can be transmitted as a two-dimensional weighting value, owing to the inclusion of the weight calculation means for calculating the weight for each directional axis of the probability distribution model based on the probability distribution model and the like included in the accuracy information at the time of location estimation in various sensors such as the radio wave detecting unit and the image analyzing unit and calculating the inclination of the directional axes and the weighting value of each of the axes. This brings advantages that, in the parameter updating means in the various sensor analyzing units, with the use of two-dimensional weighting information, for example, only the weight component corresponding to the distance direction from each radio wave sensor can be extracted, and learning and updating of the parameters can be performed with higher reliability in accordance with probability distribution of location errors having different properties depending on the various sensors.

Note that the second example embodiment described above brings advantages that a case in which the location estimation error of the camera is larger depending on a place or the like, such as an area distant from the camera, can be flexibly coped with, owing to the inclusion of the location information integrating unit that uses the integrated location obtained by weighting and integrating the location estimation results from various sensors using the accuracy information as the correct location. In this case as well, with the use of the accuracy information from each sensor analyzing unit, the reliability for the integrated location is calculated as the weighting information and is then transmitted in the weight calculating unit, and thus learning and updating of the parameters in various sensor analyzing units can be performed with higher reliability.

The third effect is that an enhancement degree of the location estimation accuracy is further increased synergistically owing to the configuration that the accuracy of association determination in the sensor fusion unit can also be enhanced when the location estimation accuracy is dynamically enhanced through learning and updating of the parameters. The reason is that, as illustrated in the first example embodiment described above, the sensor fusion unit includes the location accuracy learning unit that learns the location estimation accuracy and dynamically changes the association determination criterion in the association determining unit from the convergence degree. In other words, the reason is that association determination reflecting the enhancement of the location accuracy can be performed, and the correct location and the weighting information can be transmitted with higher reliability and in a shorter period of time. As a result, the location estimation accuracy can be enhanced synergistically with higher reliability and in a shorter period of time.

The fourth effect is that flexibility and extensibility for various sensors are high. The reason is, as illustrated in the second example embodiment described above, the inclusion of an interface and a correct data transmission function in consideration of supporting various sensors, such as image analysis using a camera, radio wave detection using a radio wave sensor, radar analysis using various radars, various laser analysis (LiDAR and the like), and acoustic wave detection using an acoustic sensor. Specifically, the reason is as follows: as an example of the sensor fusion unit, in the association determination processing in the association determining unit, the weight calculation processing in the weight calculating unit, and the location information integration processing in the location information integrating unit, the accuracy information (probability distribution, standard deviation, variance, and the like in consideration of the directional axes) at the time of location estimation in consideration of characteristics of various sensors is used, and when the accuracy information at the time of location estimation in the various sensors can be modeled into similar probability distribution, this can be implemented for any sensor.

Further, as illustrated in FIG. 14, the sensor information integration method according to the example embodiment described above also brings advantages that any of a case of integrating the location estimation information in two-dimensional location coordinates (plane coordinates), a case of integrating the location estimation information in three-dimensional location coordinates (spatial coordinates), and the like can be supported.

Further, owing to these effects as described above, as advantages for entities that actually install and operate the system, burden and man-hours (SI man-hours or the like) required for the installation and introduction, such as preliminary site surveys and calibration at the time of installation of a radio wave sensor and a camera and preliminary training for acquiring and learning the correct value in advance can be effectively reduced. Further, there are also advantages that changes of an installation environment, such as a change of a space due to addition and removal of an obstruction, a building, and a container, and a change of times such as early morning, daytime, evening, and night can also be tracked and handled with less man-hours. Specifically, first installation can be performed using already stored initial parameters and the location estimation accuracy can be autonomously optimized in accordance with an environment while being operated, and thus burden and man-hours required not only for training at the time of installation and introduction but also recalibration or the like due to environment change can also be reduced.

### 6. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

Further, an apparatus (for example, one or more apparatuses (or units) out of a plurality of apparatuses (or units) constituting a location estimation system, or a module for one of the plurality of apparatuses (or units)) including the constituent element(s) (for example, the first location estimating unit, the second location estimating unit, the association determining unit, the weight calculating unit, and/or the parameter updating unit) of the location estimation system described in the Specification may be provided. The plurality of apparatuses (or units) may include a memory configured to store a program (instructions) and one or more processors that can execute the program (instructions). Moreover, methods including processing of the constituent elements may be provided, and programs for causing a processor to execute processing of the constituent elements may be provided. Moreover, non-transitory computer readable recording media (non-transitory computer readable medium) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

A location estimation system comprising:

a first location estimating unit configured to estimate first location information related to a target object;

a second location estimating unit configured to estimate second location information related to a target object;

an association determining unit configured to determine association between the target object whose location is estimated from the first location information and the target object whose location is estimated from the second location information, based on the first location information and the second location information;

a weight calculating unit configured to calculate correct location information of the target object and weighting information of the correct location information, based on accuracy information of the second location information and determination results of the association; and

a parameter updating unit configured to update a parameter for estimating the first location information, based on the correct location information and the weighting information.

### (Supplementary Note 2)

The location estimation system according to supplementary note 1, wherein

the parameter updating unit is configured to update the parameter by weighting a correct value as learning data using the correct location information and the weighting information when updating the parameter used for the estimation of the first location information.

### (Supplementary Note 3)

The location estimation system according to supplementary note 1 or 2, wherein

the weight calculating unit is configured to calculate, based on a probability distribution model included in the accuracy information of the second location information, inclinations of directional axes of the probability distribution model and a weighting value corresponding to each of the directional axes.

### (Supplementary Note 4)

The location estimation system according to supplementary note 3, wherein

the parameter updating unit is configured to calculate a weighting component acting on the parameter used for the estimation of the first location information by the first location estimating unit from the weighting value corresponding to the inclinations of the weighting information, and to weight the calculated component to corresponding correct location information.

### (Supplementary Note 5)

The location estimation system according to supplementary note 3 or 4, wherein

the directional axes include at least two directional axes of an angular direction, an altitude direction, and a depth direction.

### (Supplementary Note 6)

The location estimation system according to any one of supplementary notes 1 to 5, wherein

the association determining unit is configured to calculate a determination criterion of the association from accuracy information of the first location information and the accuracy information of the second location information.

### (Supplementary Note 7)

The location estimation system according to any one of supplementary notes 1 to 5, wherein

the association determining unit is configured to learn location estimation accuracy from comparison between the first location information and the second location information, and to update a determination criterion of the association using the learned location estimation accuracy.

### (Supplementary Note 8)

The location estimation system according to any one of supplementary notes 1 to 7, further comprising

a location information integrating unit configured to calculate integrated location information using the first location information, the second location information, accuracy information of the first location information, and the accuracy information of the second location information.

### (Supplementary Note 9)

The location estimation system according to any one of supplementary notes 1 to 8, wherein

the weight calculation means is configured to calculate the weighting information using the first location information, the second location information, accuracy information of the first location information, and the accuracy information of the second location information.

### (Supplementary Note 10)

A location estimation method comprising:

estimating first location information related to a target object;

estimating second location information related to a target object;

determining association between the target object whose location is estimated from the first location information and the target object whose location is estimated from the second location information, based on the first location information and the second location information;

calculating correct location information of the target object and weighting information of the correct location information, based on accuracy information of the second location information and determination results of the association; and

updating a parameter for estimating the first location information, based on the correct location information and the weighting information.

(Supplementary note 11)

A program that causes a processor to execute:

estimating first location information related to a target object;

estimating second location information related to a target object;

determining association between the target object whose location is estimated from the first location information and the target object whose location is estimated from the second location information, based on the first location information and the second location information;

calculating correct location information of the target object and weighting information of the correct location information, based on accuracy information of the second location information and determination results of the association; and

updating a parameter for estimating the first location information, based on the correct location information and the weighting information.

### (Supplementary Note 12)

A non-transitory computer readable recording medium storing a program that causes a processor to execute:

estimating first location information related to a target object;

estimating second location information related to a target object;

determining association between the target object whose location is estimated from the first location information and the target object whose location is estimated from the second location information, based on the first location information and the second location information;

calculating correct location information of the target object and weighting information of the correct location information, based on accuracy information of the second location information and determination results of the association; and

updating a parameter for estimating the first location information, based on the correct location information and the weighting information.

This application claims priority to JP 2019-090646 filed on May 13, 2019, the entire disclosure of which is incorporated herein.

### INDUSTRIAL APPLICABILITY

In a location estimation system that performs integration (sensor fusion) of a plurality of pieces of location information by collaborating the pieces of location information and the like estimated using a plurality of sensors such as a camera and a radio wave sensor, for example, to achieve high accuracy, the pieces of location information can be accurately estimated.

### REFERENCE SIGNS LIST

100, 101, 102 Location estimation system
32, 110 First location estimating unit
42, 120 Second location estimating unit
71, 130 Association determining unit
72, 82, 140 Weight calculating unit
33, 43, 63, 150 Parameter updating unit

What is claimed is:

1. A location estimation system comprising one or more apparatuses each including a memory storing instructions and one or more processors configured to execute the instructions, the one or more apparatuses are configured to:
estimate first location information related to a target object;
estimate second location information related to a target object;
determine association between the target object whose location is estimated from the first location information and the target object whose location is estimated from the second location information, based on the first location information and the second location information;
calculate correct location information of the target object and weighting information of the correct location information, based on accuracy information of the second location information and determination results of the association; and
update a parameter for estimating the first location information, based on the correct location information and the weighting information.

2. The location estimation system according to claim 1, wherein
the one or more apparatuses are configured to update the parameter by weighting a correct value as learning data using the correct location information and the weighting information when updating the parameter used for the estimation of the first location information.

3. The location estimation system according to claim 1, wherein
the one or more apparatuses are configured to calculate, based on a probability distribution model included in the accuracy information of the second location information, inclinations of directional axes of the probability distribution model and a weighting value corresponding to each of the directional axes.

4. The location estimation system according to claim 3, wherein
the one or more apparatuses are configured to calculate a weighting component acting on the parameter used for the estimation of the first location information by the first location estimating unit from the weighting value corresponding to the inclinations of the weighting information, and to weight the calculated component to corresponding correct location information.

5. The location estimation system according to claim 3, wherein
the directional axes include at least two directional axes of an angular direction, an altitude direction, and a depth direction.

6. The location estimation system according to claim 1, wherein
the one or more apparatuses are configured to calculate a determination criterion of the association from accuracy information of the first location information and the accuracy information of the second location information.

7. The location estimation system according to claim 1, wherein
the one or more apparatuses are configured to learn location estimation accuracy from comparison between the first location information and the second location information, and to update a determination criterion of the association using the learned location estimation accuracy.

8. The location estimation system according to claim 1, wherein
the one or more apparatuses are further configured to calculate integrated location information using the first location information, the second location information, accuracy information of the first location information, and the accuracy information of the second location information.

9. The location estimation system according to claim 1, wherein
the one or more apparatuses are configured to calculate the weighting information using the first location information, the second location information, accuracy information of the first location information, and the accuracy information of the second location information.

10. A location estimation method comprising:
estimating first location information related to a target object;
estimating second location information related to a target object;
determining association between the target object whose location is estimated from the first location information and the target object whose location is estimated from the second location information, based on the first location information and the second location information;
calculating correct location information of the target object and weighting information of the correct location information, based on accuracy information of the second location information and determination results of the association; and
updating a parameter for estimating the first location information, based on the correct location information and the weighting information.

11. (canceled)

12. A non-transitory computer readable recording medium storing a program that causes a processor to execute:
estimating first location information related to a target object;
estimating second location information related to a target object;
determining association between the target object whose location is estimated from the first location information and the target object whose location is estimated from the second location information, based on the first location information and the second location information;
calculating correct location information of the target object and weighting information of the correct location information, based on accuracy information of the second location information and determination results of the association; and
updating a parameter for estimating the first location information, based on the correct location information and the weighting information.
